(19) United States
(12) Patent Application Publication
(10) Pub. No.: US 2019/0087427 A1
(43) Pub. Date: Mar. 21, 2019

(54) SYSTEM AND METHOD FOR SECURE CONTENT DOWNLOADS

(71) Applicant: DeCarlo McKeithan, Murrieta, CA (US)

(72) Inventor: DeCarlo McKeithan, Murrieta, CA (US)

(21) Appl. No.: 16/134,609

(22) Filed: Sep. 18, 2018

Related U.S. Application Data
(60) Provisional application No. 62/560,133, filed on Sep. 18, 2017.

(51) Int. Cl. G06F 17/30; G06F 21/10; G06F 21/62; G06F 21/44

(52) U.S. Cl. CPC G06F 17/30047; G06F 21/44; G06F 21/6209; G06F 21/10

(57) ABSTRACT

The present embodiments disclose a system for providing secure content. The system includes a computing device having a camera operably coupled to an application. The application has a plurality of hashed content. A server has a system processor operably coupled to the computing device. The system processor is configured to generate a unique QR code, associate the unique QR code with one of the plurality of hashed content, associate the UID of the computing device with the QR code, and provide hashed content to the computing device having the associated UID.

### CROSS REFERENCE TO RELATED APPLICATIONS

This application claims priority to U.S. Provisional Application 62/560,133 filed Sep. 18, 2017, entitled “Secure QR Code & Content Downloads” which is hereby incorporated by reference.

### TECHNICAL FIELD

The embodiments presented relate to a system and method for securely downloading content by a user.

### BACKGROUND

Marketing professionals are continually looking for more convenient ways to entice consumers to engage with their content. In recent years, the ubiquitous use of the internet via mobile devices has provided increasingly straightforward means for accessing content contained in promotional items. Marketers no longer need to rely on users remembering or saving a name, website address, promotional items, or other content as their mobile devices can connect them to the content source.

Content is often downloaded directly from a network to a computing device. Scannable codes, such as Quick Response (QR) codes are a secure means for downloading content onto a mobile device. However, QR codes are universal to the population to which they are provided, allowing any number of mobile devices to scan the QR code, and access the associated content. While the utilization of QR codes is convenient, there is no system for restricting access to the QR code once the content has been accessed by a specific mobile device.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

The present embodiments disclose a system for providing secure content. The system includes a computing device having a camera operably coupled to an application. The application has a plurality of hashed content. A server has a system processor operably coupled to the computing device. The system processor is configured to generate a unique QR code, associate the unique QR code with one of the plurality of hashed content, associate the UID of the computing device with the QR code, and provide hashed content to the computing device having the associated UID.

Some embodiments restrict the use of the QR code to that of a single user within the system of users. This permits the QR code to be scanned by a user and the content to be downloaded to a single computing device.

In one aspect, the hashed content is an audio file or a video file.

In one aspect, the articles are printed articles provided to the user such as a concert ticket.

In one aspect, a comparator operably coupled to the system processor is configured to compare the UID with the content file to prohibit another UID from accessing the plurality of content associated with the QR code.

In another aspect, an administrator in communication with an administrator interface permits the administrator to upload the plurality of hashed content to the database.

Moreover, in accordance with a preferred embodiment of the present invention, other aspects, advantages, and novel features of the present invention will become apparent from the following detailed description in conjunction with the drawings.

### BRIEF DESCRIPTION OF THE DRAWINGS

A more complete understanding of the present invention and the advantages and features thereof will be more readily understood by reference to the following detailed description when considered in conjunction with the accompanying drawings wherein:

FIG. 1 illustrates a block diagram of a system for providing secure content, according to some embodiments;

FIG. 2 illustrates a screenshot of the administrative interface, according to some embodiments;

FIG. 3 illustrates a block diagram of the content engine, according to some embodiments;

FIG. 4 illustrates a front elevation view of an article whereon a QR code is provided, according to some embodiments;

FIG. 5 illustrates a block diagram of the user flow of the system, according to some embodiments; and

FIG. 6 illustrates a block diagram of the QR code generation and utilization process, according to some embodiments.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

Before describing in detail exemplary embodiments, it is noted that the embodiments reside primarily in combinations of components related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments described herein provide for a system for downloading content using a quick response (QR) code, which is provided with an article. The QR code will only allow for a single device to access the code as shown and described herein.

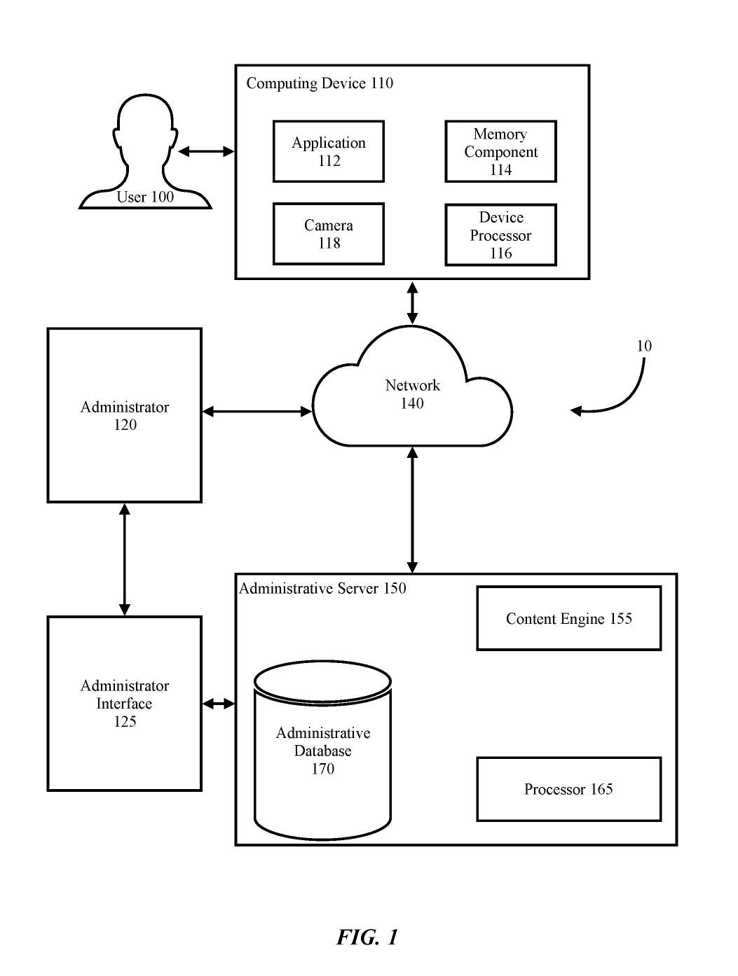

In reference to FIG. 1, system 10 includes a user 100 having a computing device 110 capable of scanning (via camera 118) downloading, processing, and storing content thereon. The user 100 downloads application 112 to the memory component 114 of the computing device 110. An artisan understands that user 100 can refer to any single user within a community of users. The computing device 110 is specific to each user 100 within the community of users.

An administrator 120 is in communication with the network 140. The administrator 120 can create and upload content via content engine 155 to a database 170 associated with the administrative server 150. Once content is downloaded, system processor 165 may generate QR codes, in addition to facilitating other functionalities described herein. The administrator selectively uploads the content 210 to the database.

Network 140 may be the Internet, a cellular network, a wired network, a wireless network, a cloud computing network, or other conventional network technology recognized in the art. It is to be understood that, in practice. there will be plural and likely a large number of computing devices 110 used by each of the user 100 within the community of users connected to the network 140. Also, the administrative server 150 may be a unitary device but would preferably be implemented as a server farm or a distributed computing system to handle large capacities of content stored in a database 170 and the many simultaneous connections with computing devices 130. Further examples of communication networks include a local area network (“LAN”), a wide area network (“WAN”), an inter-network (e.g., the Internet), and peer-to-peer networks (e.g., ad hoc peer-to-peer networks).

The computing devices 110 may include conventional components such as one or more applications 112, one or more memory components 114, and one or more processors 116. Examples of computing devices 110 include such known mobile devices as smartphones, tablets, etc., but it is to be understood that the computing device 110 need not be a mobile device and that the inventive concepts apply to other computing devices such as a desktop computer.

Processors 116 and system processor 165 are suitable for the execution of a computer program include, by way of example, both general and special purpose microprocessors and any one or more processors of any digital computing device. Generally, the processor 116 will receive instructions and data from a read-only memory or a random-access memory or both. The essential elements of a computing device 110 are a processor 116 for performing actions in accordance with instructions and one or more memory devices 114 for storing instructions and data. Generally, a computing device 110 will also include, or be operatively coupled to receive data from or transfer data to, or both, one or more mass storage devices for storing data, e.g., magnetic, magneto-optical disks, or optical disks. However, a computing device 110 need not have such devices. Moreover, a computing device 110 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Memory components 114 suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor 116 and the memory 114 can be supplemented by, or incorporated in, special purpose logic circuitry.

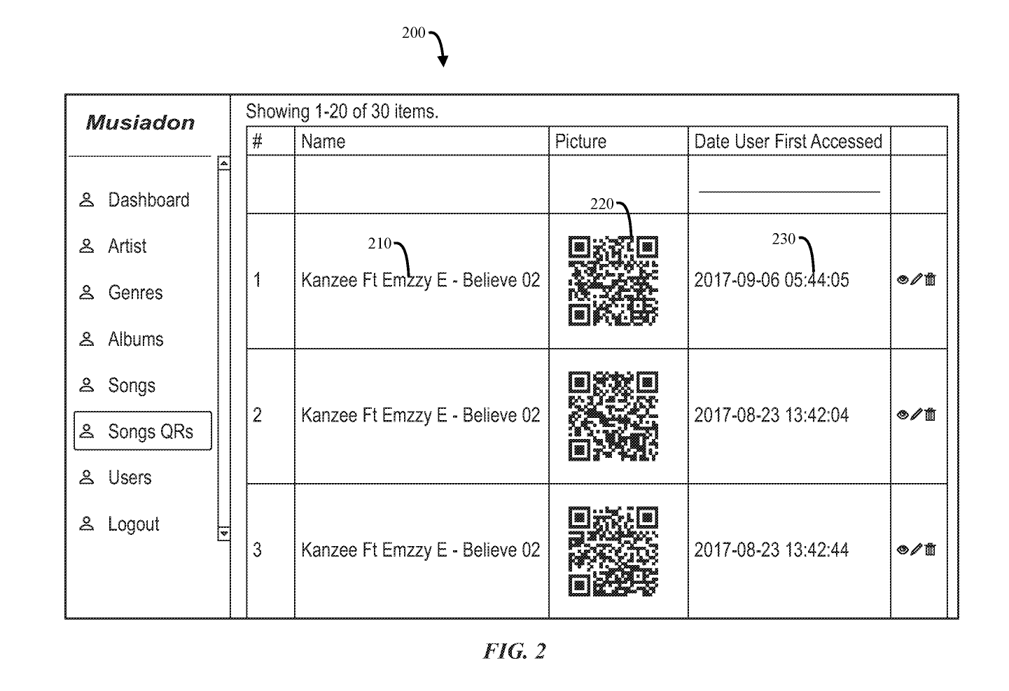

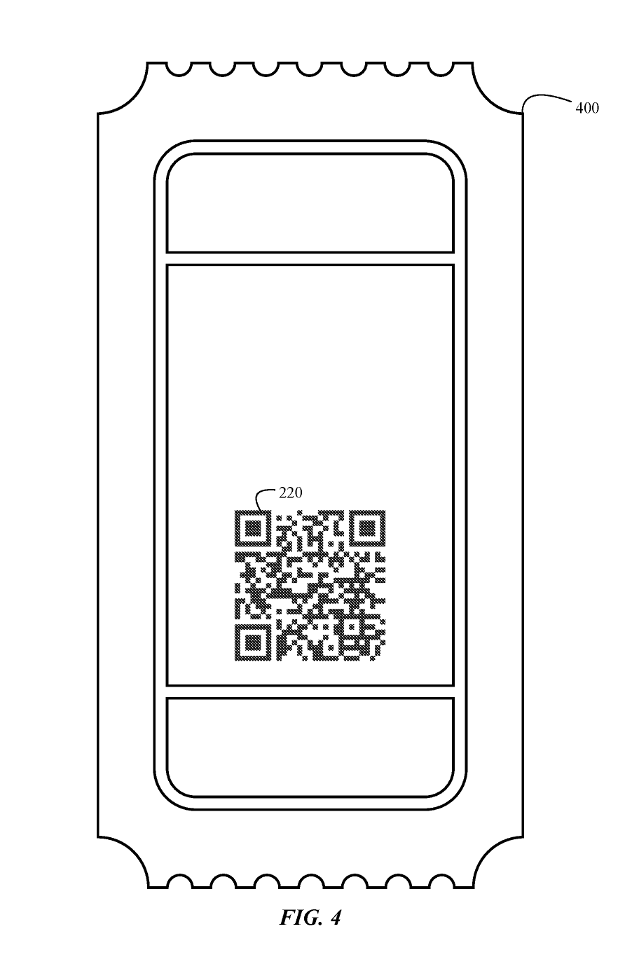

In reference to FIG. 2, a screenshot of the administrator interface 200 is shown. The administrator 120 can access a secure web portal having the administrator interface 200 wherein the administrator 120 can upload content 210 accessed by the user 100. The term “content” can refer to hashed or un-hashed content. The content can be hashed using any hashing method known in the arts. In one example, the content 210 includes audio data for one or more songs or albums related to a musical artist. Once the content 210 has been uploaded, the administrator selects a number for the number of unique QR codes 220 to generate and to be printed on an article 400 (see FIG. 4). The administrator can also access a log 230 of which user 110 is utilizing the QR code 220, and relevant dates such as the date the QR code 220 was first scanned.

While the example of a QR code 220 is utilized in some embodiments, a skilled artisan will recognize that alphanumeric codes, barcodes, readable code images, and similar machine-readable codes can be implemented.

Once the article 400 is printed having the QR code 220 provided thereon, the article is distributed to be provided and engaged with by the user 100 and community thereof. Engaging with the article 400, the user scans the QR code 220 using their computing devices 110 cameras 118.

The QR codes can include any other URL interactive code format such that these URL internet connecting “interactive codes” allow smartphone device users 100 or users of any computing device 110 with an optical scanning element such as a camera 118 to scan the QR code and be linked to both static data that is typically hosted by administrative server 150, and or specific internet URL's that can host much broader bandwidth of data that includes text, multiple languages, audio, video, special promotions, coupons, testimonials, product specifications, certifications, product demonstrations, dealer locations, retail locations, image galleries, GPS coordinates, warranty product registration forms, and opt-in interactive forms.

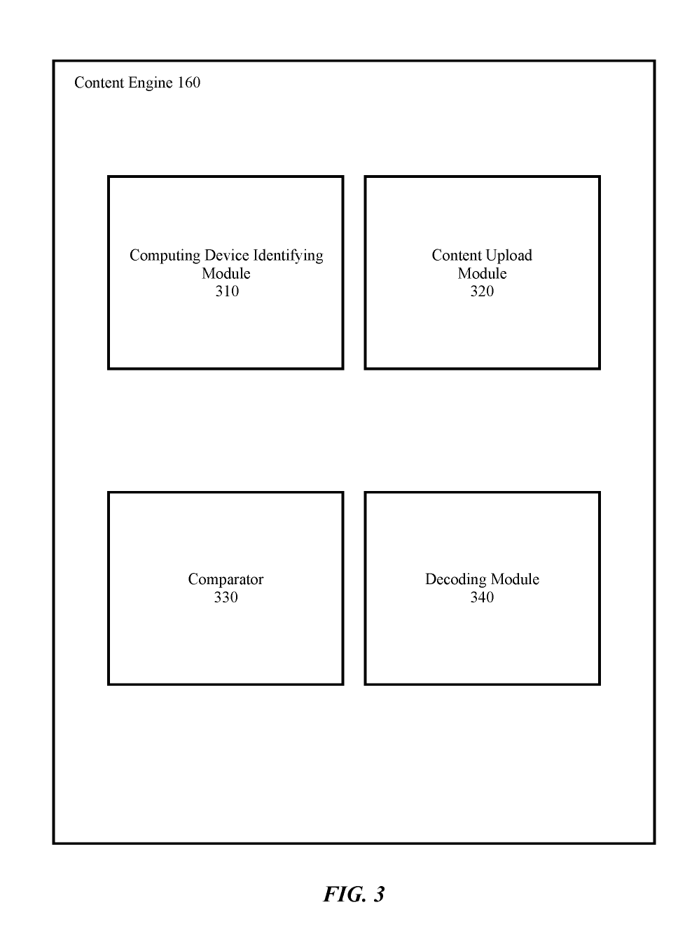

FIG. 3 illustrates the content engine 155 having a device identifying module 310, a content upload module 320, comparator 330, and a decoding module 340. The device identifying module 310 determines the unique identifier (UID) of the computing device 110 which has scanned the QR code 220. The content upload module 320 permits the administrator 120 to upload content 210 (such as an audio file) to the server 150 where it is stored in the database 170. The comparator 330 compares UID's transmitted by the variety of computing devices 110 within the community of users with the UID stored within the database 170 following the scanning (via the camera 118) of the QR code 220 by a single user 100. The comparator determines if the QR code 220 and associated UID matches the stored UID in the database 170. If a match is found, the content is provided to the user 100. However, if the UID does not match the stored UID in the database 170, the user 100 is not provided with the content 210. The decoding module 340 decodes the QR code 220.

In reference to FIG. 4, the article 400 on which the QR code 220 is printed is shown. QR codes 220 or similar internet URL codes can be used in or on any product, packaging, or single-use packaged product or product sample for sale, or use as premium incentive give away, to include but not limited to product or product sample provided in or as one or more of printed areas, sheets, wipes, vials, pouches, packets, patches, containers, and the like. In one example, the QR code 220 is provided by printing the QR code 220 onto a concert ticket 410. The ticket 410 is provided to those attending the concert event which will allow the attendees (who may be users 100) to interact with the QR code 220 by scanning using the camera 118 feature of the computing device 110. The QR code 220 may provide a link which permits the user 100 to access the hashed content 210 which may be a downloadable audio file. The system 10 then associates the QR code 220 with the computing device 110 which scanned the QR code 220 by determining the UID of the computing device 110.

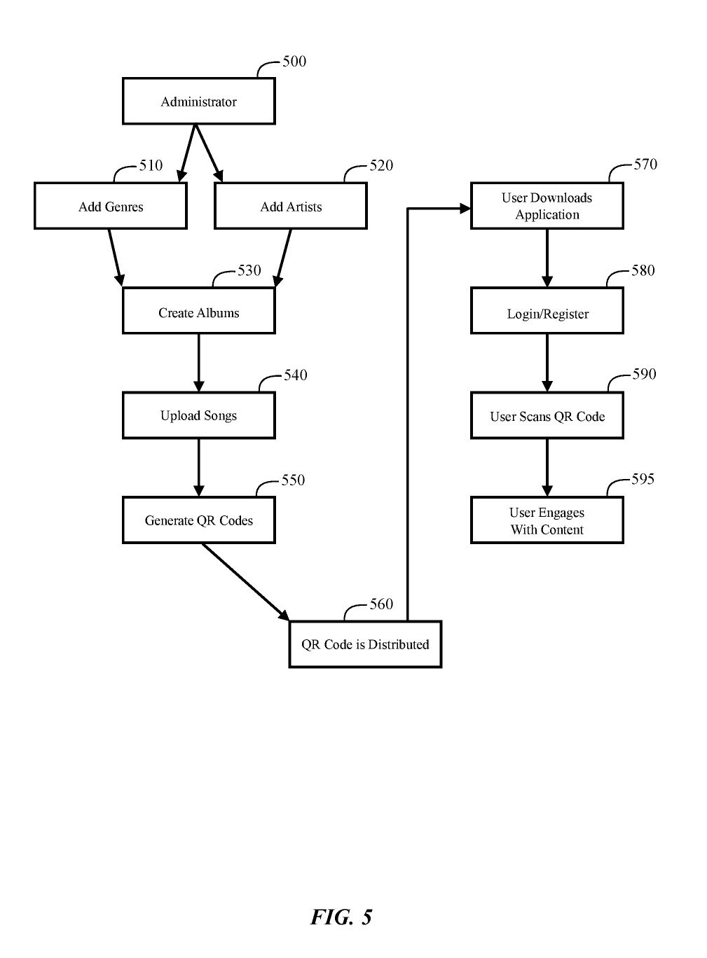

FIG. 5 provides a user flow of the system 10. In block 500, the administrator 120 adds genres (block 510) and artists (block 520) or similar content 210 categories to the database 170. In block 530, the administrator creates an album for at least one artist and uploads songs (block 540) to the database 170. Songs can be uploaded in the form of an audio file. However, videos, music videos, or related content 210, which is now hashed content, may be uploaded by the administrator 120. QR codes 220 are generated (block 550) which correspond to the specific content 210 determined by the administrator 120. The article 400 is then distributed (block 560) and provided for user 100 engagement.

In further reference to FIG. 5, the user 100 downloads the application 112 to their computing device 110 in block 570. The user 100 must be registered as a permitted user (by a login/registration in block 580) within the application 112 to permit capturing of the QR code 220 (block 590). Once the QR code 220 is scanned, the user 100 is provided with the downloadable content 210 via the application 112 such that the user can download the content 210 to the mobile device 110 memory 114. This permits the user to engage with the content 210 (by listening and or watching the content as shown in block 595). Once the QR code 220 has been scanned by the computing device 110, the UID is stored in the database 170 and associated with the QR code 220. This prohibits any other computing device from scanning the QR code 220 and engaging with the content 210.

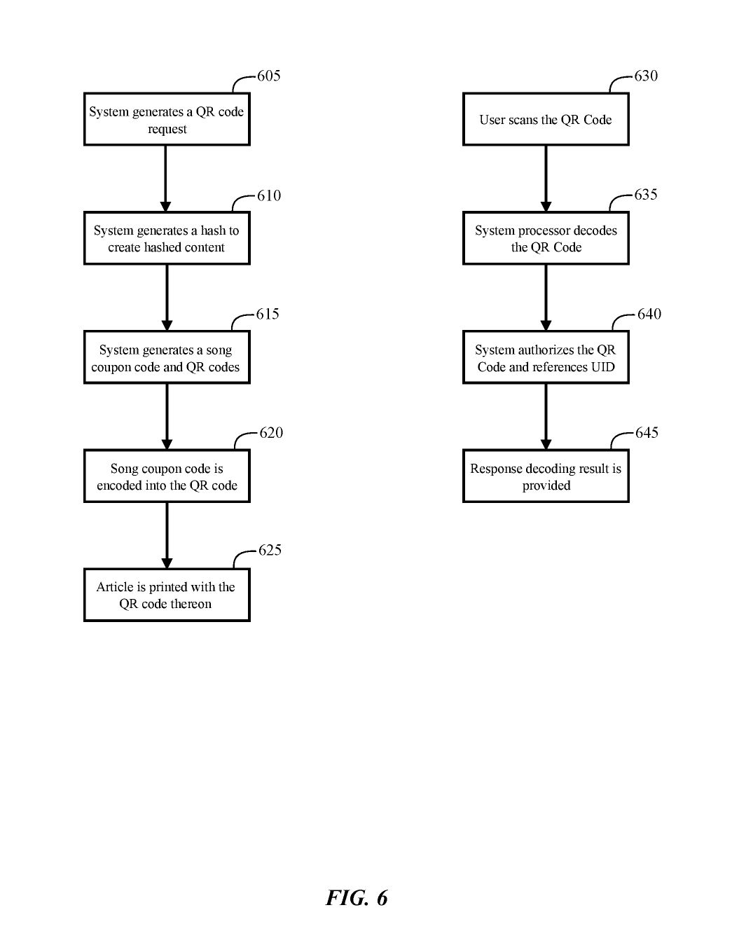

FIG. 6 illustrates a flowchart for the QR code generation and utilization processes. In block 605, the system 10 generates a QR code request. In step 610, the system generates a hash to create the hashed content 210. In step 615, the system 10 generates a song coupon code and QR codes 220 (the number of which is determined by the administrator 120). The song coupon code is encoded into the QR code 220 in step 620, and the article 400 is printed having the QR code 220 thereon in step 625.

Once the user 100 is provided with the article 400, the camera 118 of the computing device 110 is used to scan the QR code 220. The user 100 scans the QR code 220 in step 630 and the system processor 165 decodes the QR code 220 in step 635. The application 112 may access the camera 118 of the computing device 110 to perform the scan of the QR code 220. In step 640, a query is made to the system 10 to authorize the QR code 220 and reference the UID of the computing device 110 with the coupon code. Step 645, the response decoding result is provided.

In some embodiments, the UID of each computing device 110 is encrypted such that the database 170 is secure of sensitive information. In addition, any user 100 information such as names, login credentials, etc. are encrypted to promote a secure data storage environment for the system 10.

In some embodiments, the system processor generates a QR code 220 which is printed onto an article 400. The unique QR code 220 is associated with the content 210 which can be hashed by the system 10. The UID of the computing device 210 is associated with the QR code once the user 100 scans the QR code 220 with the camera 118. Once the QR code has been scanned, content 210 is provided to the computing device 110 having the associated UID. The database 170 is configured to store the content 210, the UID(s), and the associated QR codes 220. The UID is associated with the QR code 220 prohibits other UID's belonging to the computing devices 110 of other users in the community to access the content 210.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for providing secure content, the system comprising:
a computing device including a camera operably coupled to an application, the application including a plurality of hashed content;
a server including a system processor operably coupled to the computing device, the system processor configured to perform the following;
generating a unique QR code;
associating the unique QR code with one of the plurality of hashed content;
associating a UID of the computing device with the QR code; and
providing one of the plurality of hashed content to the computing device having the associated UID,
a database operably coupled to the system processor and configured to store the plurality of hashed content and to store the QR code with the associated UID.

2. The system of claim 1, wherein the plurality of hashed content is an audio file.

3. The system of claim 1, wherein the plurality of hashed content is a video file.

4. The system of claim 1, wherein the plurality of articles are printed articles provided to the user.

5. The system of claim 1, wherein the database is configured to store the UID.

6. The system of claim 5, wherein a comparator operably coupled to the system processor is configured to compare the UID with the content file to prohibit another UID from accessing the plurality of content associated with the QR code.

7. The system of claim 1, further comprising an administrator in communication with an administrator interface, the administrator interface permitting the administrator to upload the plurality of hashed content.

8. The system of claim 7, wherein the administrator selectively uploads one of the plurality of hashed content to the database.

9. The system of claim 8, wherein the system processor hashes the plurality of hashed content and transmits the hashed content to the database.

10. A system for providing secure content, the system comprising:
one or more computing devices each including a camera to scan a QR code printed on a plurality of articles, the one or more computing devices configured to provide an application to a plurality of users;
a database operably coupled to a system processor and configured to store a plurality of hashed content provided by one or more administrators;
a server operably coupled to the database and configured to receive a request for the plurality of hashed content;
a computing device identifying module in operable communication with the server and configured to perform the following:
generating the QR code;
associating the QR code with one of the plurality of hashed content;
identifying a UID for each of the plurality of computing devices and associating the UID with the plurality of hashed content; and
decoding the QR code; and
providing the plurality of hashed content to a user.

11. The system of claim 10, wherein the plurality of hashed content is an audio file.

12. The system of claim 10, wherein the plurality of articles are printed articles provided to the user.

13. The system of claim 10, wherein the database is configured to store the UID.

14. The system of claim 13, wherein the system processor is configured to associate the UID with one of the plurality of hashed content to prohibit another UID from accessing the one of the plurality of hashed content associated with the QR code.

15. A method for providing secure content, the method including a computing device having a camera, the computing device operably coupled to an application, the application including a plurality of hashed content, the method comprising the steps of:
generating, via a system processor, a request for a QR code;
generating, via the system processor, a hashed content file;
storing, via a database is operably coupled to the system processor, the hashed content file;
associating, via the system processor, the hashed content file with the QR code;
providing the hashed content file to a user.

16. The method of claim 15, further comprising a comparator operably coupled to the system processor.

17. The method of claim 16, wherein the comparator is configured to associate the UID with the content file to prohibit another UID from accessing the plurality of content associated with the QR code.

18. The method of claim 15, further comprising an administrator in communication with an administrator interface, the administrator interface permitting the administrator to upload the plurality of hashed content.

19. The method of claim 15, wherein the plurality of hashed content is an audio file.

20. The method of claim 15, wherein the plurality of articles are printed articles provided to a user.
